(19) United States
(12) Patent Application Publication
(10) Pub. No.: US 2007/0260099 A1
(43) Pub. Date: Nov. 8, 2007

(54) Catalytic System for Polymerisation of Lower Alpha Alkene

(76) Inventors: Sumit Bhaduri, Chembur (IN); Virendra Kumar Gupta, Chembur (IN); Krishna Sarma, Chembur (IN)

Correspondence Address: Vista IP Law Group LLP, 2040 MAIN STREET, 9TH FLOOR, IRVINE, CA, 92614, US

(21) Appl. No.: 10/589,141

(22) PCT Filed: Feb. 16, 2004
(86) PCT No.: PCT/IN04/00043

§ 371 Date: Aug. 10, 2006

(51) Int. Cl. C08F 10/00; C08F 4/654

(52) U.S. Cl. 585/636; 502/104; 502/127

(57) ABSTRACT

Catalytic system for polymerization of lower alpha alkene including a selectivity control agent which consists of naturally derived pure isomers of tartrates such as esters of (2-R,3-R)-dihydroxy-butane-1,4dicarboxylic acid or (2-S,3-S)-dihydroxybutane-1,4-dicarboxylic acid. The molar ratio of the optically pure isomers of the tartrates to titanium being 0.0375 to 1.5.

This invention also relates to process for the preparation of the catalytic system and process for the polymerisation of lower alpha alkene using the catalytic system.

### BACKGROUND ART

Polymers of lower alpha alkene or olefins such as ethylene, propylene or 1-butene find applications in the manufacture of a variety of articles including plastic bags or sheets or automobile parts. Of particular interest in polymer production is polypropylene with a high degree of isotacticity i.e. the extent of orientation of the methyl groups in the polymer in the same direction, which shows high crystallinity. Polymerisation of lower alpha alkene such as ethylene or propylene involves reacting the monomer with a catalyst under polymerisation conditions. The early polymerisation catalysts were of relatively low activity and the polymers formed contained significant amounts of the catalyst residues, which had to be removed by deashing steps. The more recent alpha alkene polymerisation catalysts are of two types viz single site metallocene and non-metallocene catalysts and heterogeneous solid catalysts. The single site catalysts comprise metallocenes or co-ordination complexes of transition metals and a cocatalyst such as methyl aluminoxane and produces polymer of low polydispersity.

Heterogeneous solid catalysts are the most commonly used catalysts, especially in the bulk production of polyethylene or polypropylene due to their high activity and ease of operation. These catalysts are sometimes referred to as Ziegler-Natta catalysts after the name of the inventors (Ziegler et al U.S. Pat. Nos. 3,903,017; 4,063,009 and 4,125,698 and Natta et al U.S. Pat. Nos. 3,197,452 and 3,957,743). Several improvements in terms of activity of the catalyst as measured by the amount of polymer produced per unit weight of catalyst and selectivity of the catalyst usually measured for polypropylene by measuring the amount of xylene soluble fraction have since taken place [Chapter 1 (by Brian L Goodall) and Chapter 9 in “Polypropylene and other Polyolefins; Polymerization and Characterization” edited by Ser van der Ven, Elsevier, New York, 1990].

Heterogeneous solid catalysts for polyethylene and polypropylene comprise a procatalyst and a cocatalyst and optionally an external electron donor or selectivity control agent (SCA). For polypropylene with high isotacticity one of the components of the procatalyst is an internal electron donor which works in tandem with the optional SCA. The procatalysts are synthesized by chlorination of an organomagnesium compound such as magnesium ethoxide with a chlorinating agent such as titanium tetrachloride in a hydrocarbon or halohydrocarbon solvent such as toluene or chlorobenzene in a multi step reaction so that simultaneous fixing of titanium tetrachloride on magnesium chloride occurs. The internal electron donor is added during the preparation of the polypropylene procatalyst. The procatalyst for polypropylene may also be prepared by milling together anhydrous magnesium chloride with titanium tetrachloride and an internal electron donor.

European Patent No 336, 545 of Bailly et al describes the optional use of aromatic esters such as ethyl benzoate, methyl paratoluate or dibutyl or diisobutyl phthalate as electron donors. U.S. Pat. No. 4,107,414 of Giannini et al, describes the use of ethyl benzoate, 1,2, dimethoxy benzene or tetrahydrofuryl methyl ether as internal electron donors and esters of oxygenated organic and inorganic acids as external electron donors. Esters of aromatic acids are reported to give best results. U.S. Pat. No. 4,522,930 of Albizatti et al. describes the use of ethers, ketones, lactones, esters and compounds containing nitrogen phosphorous and/or sulfur atoms as internal electron donors, and compounds with Si—OR, Si—OCOR bonds as SCA. Shamshoum in European Patent No 0605380A2 also reports the use of alkoxy silanes as SCA with commercial Ziegler-Natta catalysts. Use of diether compounds as effective electron donors has been described in European Patent No 728,741 of Morini et al, European Patent No 361,949 of Scordamaglia et al and European Patent No 362,705 of Barbe et al. Use of diethers with alkoxysilane external donors is described by Iskola et al in U.S. Pat. No. 5,869,418. Use of diethers as internal electron donors eliminating the need of SCA is reported in U.S. Pat. No. 5,068,213 of Albizzati. U.S. Pat. No. 5,891,817 of Shamshoum et al describes the use of di-n-alkyl di-methoxy silanes as SCA in combination with diesters of phthalic acid as internal electron donors. U.S. Pat. No. 6,451,726 of Tagge describes the use of unsaturated nitrogen containing compounds including bipyridyl compounds as internal electron donor or as SCA. U.S. Pat. No. 6,399,837 of Wilson et al describes the use of 1-ethoxy-2-n-alkoxybenzene compounds as internal electron donor or as SCA or as both.

There is described in our PCT publication No WO 02/44220A1 a lower alpha alkene polymerisation heterogeneous solid catalyst comprising a hydrated magnesium chloride derived procatalyst comprising a titanium tetrahalide supported on a magnesium chloride ester complex precursor. The internal electron donor ester component of the precursor is generated in situ by reaction of a magnesium chloride alcoholate with an activated carbonyl compound in the mole ratio 0.5-1:10-20.

The magnesium chloride alcoholate is formed of hydrated magnesium chloride and an aliphatic alcohol in the mole ratio of 0.5-1:10-20. The catalyst comprises a cocatalyst comprising an organoaluminium compound, the mole ratio of the aluminium to the titanium being 10-300:1. The catalyst also comprises a selectivity control agent comprising an ester or ether in the mole ratio 10-100:1 with respect to the titanium.

There is described in our PCT Publication No WO 03/62283 an olefin polymerisation titanium catalyst comprising a titanium compound and an organoaluminium compound cocatalyst supported on a soluble polysulfone comprising free reactive sulfone groups. The molar ratio of titanium to aluminium is 1-10:200 and the weight ratio of titanium to polysulfone is 0.01-0.1:0.3-2.5.

There is described in our PCT application No PCT/IN03/00152 a single step process for the preparation of lower alpha alkene polymerisation heterogeneous solid catalyst comprising an organomagnesium precursor derived procatalyst comprising magnesium chloride supported titanium chloride and an internal electron donor and an organoaluminium compound based cocatalyst. The procatalyst is obtained by single step reaction under microwave irradiation of 300 to 1200 W.

Selectivity control Agents reported in the prior art invariably have an aromatic ring and many aromatic compounds are known to be toxic and/or having other undesirable properties.

The cocatalyst is organoaluminium compound such as trialkyl aluminium or dialkyl aluminium halide. The alkyl group may be methyl, ethyl, butyl, isobutyl, hexyl and octyl and the halide may be chloride or bromide. The preferred cocatalyst is triethyl aluminium.

### OBJECTS OF INVENTION

An object of the invention is to provide a catalytic system for polymerisation of lower alpha alkene comprising SCA which is non-toxic and without side effects.

Another object of the invention is to provide a catalytic system for polymerisation of lower alpha alkene which shows high activity and selectivity.

Another object of the invention is to provide a catalytic system for polymerisation of lower alpha alkene which is economical.

Another object of the invention is to provide a process for the preparation of a catalytic system for polymerisation of lower alpha alkene comprising SCA which is non-toxic and without side effects.

Another object of the invention is to provide a process for the preparation of a catalytic system for polymerisation of lower alpha alkene, which shows high activity and selectivity.

Another object of the invention is to provide a process for the preparation of a catalytic system for polymerisation of lower alpha alkene, which is economical.

Another object of the invention is to provide a process for the polymerisation of lower alpha alkene using a catalytic system, comprising SCA which is non-toxic and without side effects.

Another object of the invention is to provide a process for the polymerisation of lower alpha alkene using a catalytic system, which shows high activity and selectivity.

Another object of the invention is to provide a process for the polymerisation of lower alpha alkene using a catalytic system, which is economical.

### DETAILED DESCRIPTION OF INVENTION

According to the invention there is provided a catalytic system for polymerisation of lower alpha alkene consisting of an organomagnesium or magnesium chloride derived procatalyst consisting of magnesium chloride supported titanium chloride and an internal electron donor and an organoaluminium based cocatalyst and a selectivity control agent, wherein the selectivity control agent consists of naturally derived optically pure isomers of tartrates such as esters of (2-R,3-R)-dihydroxy-butane-1,4-dicarboxylic acid or (2-S,3-S)-dihydroxybutane-1,4-dicarboxylic acid, the molar ratio of the optically pure isomers of the tartrates to titanium being 0.0375 to 1.5.

According to the invention there is also provided a process for the preparation of a catalytic system for polymerisation of lower alpha alkene consisting of mixing an organomagnesium or magnesium chloride derived procatalyst consisting of magnesium chloride supported titanium chloride and an internal electron donor and an organoaluminium based cocatalyst and a selectivity control agent, wherein the selectivity control agent consists of naturally derived optically pure isomers of tartrates such as esters of (2-R,3-R)-dihydroxy-butane-1,4dicarboxylic acid or (2s,3-S)-dihydroxybutane-1,4-dicarboxylic acid, the molar ratio of the optically pure isomers of the tartrates to titanium being 0.0375 to 1.5.

According to the invention there is also provided a process for the polymerisation of lower alpha alkene consisting of reacting the lower alpha alkene with a catalytic system consisting of an organomagnesium or magnesium chloride derived procatalyst consisting of magnesium chloride supported titanium chloride and an internal electron donor and an organomagnesium based cocatalyst and a selectivity control agent, wherein the selectivity control agent consists of naturally derived optically pure isomers of tartrates such as esters of (2-R,3-R)-dihydroxy-butane-1,4-dicarboxylic acid or (2-S,3-S)-dihydroxybutane-1,4-dicarboxylic acid, the molar ratio of the optically pure isomers of the tartrates to titanium being 0.0375 to 1.5 under polymerisation conditions in known manner.

Preferably, the molar ratio of the optically pure isomers of the tartrates to titanium is 0.7.

Preferably the tartrates are alkyl or cycloalkyl esters of (2-R,3-R)-dihydroxybutane-1,4-dicarboxylic acid.

The polymerisation of the lower alpha alkene using the catalyst of the invention is carried out in a known manner for instance polymerisation may be carried out in gas phase employing one or more fluidised beds of the catalyst. Alternatively it may also be conducted in a slurry phase in the presence of an inert hydrocarbon diluent like toluene or hexane. The constitutents of the polymerisation catalyst may be mixed in a vessel outside the polymerisation reactor and then transferred thereinto. Alternatively they may be mixed together in the reactor to form the catalyst in situ.

The invention is described with reference to the following example which is intended to illustrate and not to limit the scope of invention.

### EXAMPLE

Polymerization reactions were carried in the slurry phase with hexane as the diluent under a constant pressure of 5 kg for 1 hr at 70° C. as per the polymerisation data as given in the following Table. The procatalyst (0.1 GM) was mixed with triethyl aluminium co-catalyst (1.425 GM) and SCA in the amount indicated in the following Table:

TABLE

| | SCA (2-R,3-R)- | Polypropylene yield (KG |
|---|---|---|
| Internal Electron | dihydroxybutane- | per GM of procatalyst); |
| Donor of | 1,4-dicarboxylic | Selectivity |
| the Procatalyst | acid Alkyl = | (Xylene soluble %) |
| Ethyl benzoate | None | 4.0; 93 |
| | Di-n-propyl | 3.5; 95 |
| Ethyl benzoate | Di-isopropyl | 4.3; 93 |
| | Di-2-ethylhexyl | 3.7; 95 |
| | Di-n-propyl | 3.8; 94 |
| Di-isobutyl | Di-isopropyl | 4.0; 93 |
| phthalate | Di-2-ethylhexyl | 3.7; 95 |
| | Di-n-propyl | 3.7; 94 |

The Table clearly indicates that the catalytic system of the invention has excellent activity and selectivity for the polymerisation of polypropylene. According to the invention the selectivity control agent comprises naturally derived optically pure isomers of tartrates which are non-toxic and without side effects besides being economical.

1) A catalytic system for polymerisation of lower alpha alkene, the system comprising:
at least one of an organomagnesium or magnesium chloride derived procatalyst comprising magnesium chloride supported titanium chloride, an internal electron donor, and an organoaluminium based cocatalyst; and
a selectivity control agent, wherein the selectivity control agent consists of naturally derived optically pure isomers of tartrates such as esters of (2-R,3-R)-dihydroxy-butane-1,4-dicarboxylic acid or (2-8,3-8)-dihydroxybutane-1,4-dicarboxylic acid, the molar ratio of the optically pure isomers of the tartrates to titanium being 0.0375 to 1.5.

2) The catalytic system of claim 1, wherein the molar ratio of the optically pure isomers of the tartrates to titanium is 0.7.

3) The catalytic system of claim 1, wherein the tartrates are alkyl or cyclo alkyl esters of (2-R,3-R)-dihydroxybutane-1,4-dicarboxylic acid.

4) A process for the preparation of a catalytic system for polymerisation of lower alpha alkene, the process comprising:
mixing at least one of an organomagnesium or magnesium chloride derived procatalyst comprising magnesiumchloride supported titanium chloride, an internal electron donor, an organoaluminium based cocatalyst, and a selectivity control agent, wherein the selectivity control agent consists of naturally derived optically pure isomers of tartrates such as esters of (2-R,3-R)-dihydroxy-butane-1,4-dicarboxylic acid or (2-8,3-8)-dihydroxybutane-1,4-dicarboxylic acid, the molar ratio of the optically pure isomers of the tartrates to titanium being 0.0375 to 1.5.

5) The process of claim 4, wherein the molar ratio of the optically pure isomers of the tartrates to titanium is 0.7.

6) The process of claim 4, wherein the tartrates are alkyl or cyclo alkyl esters of (2-R,3-R)-dihydroxybutane-1,4-dicarboxylic acid.

7) A process for the polymerisation of lower alpha alkene, the process comprising:
reacting the lower alpha alkene with a catalytic system comprising at least one of an organomagnesium or magnesium chloride derived procatalyst comprising magnesium chloride supported titanium chloride, an internal electron donor, and an organomagnesium based cocatalyst, and a selectivity control agent, wherein the selectivity control agent consists of naturally derived optically pure isomers of tartrates such as esters of (2-R,3-R)-dihydroxy-butane-1,4-dicarboxylic acid or (2-S,3-S)-dihydroxybutane-1,4-dicarboxylic acid, the molar ratio of the optically pure isomers of the tartrates to titanium being 0.0375 to 1.5, under polymerisation conditions in a known manner.

8) The process of claim 7, wherein the molar ratio of the optically pure isomers of the tartrates to titanium is 0.7.

9) The process of claim 7, wherein the tartrates are alkyl or cyclo alkyl esters of (2˜R,3-R)-dihydroxybutane-1,4-dicarboxylic acid.
